(19) United States
(12) Patent Application Publication
(10) Pub. No.: US 2024/0262041 A1
(43) Pub. Date: Aug. 8, 2024

(54) CONTROL OF PHOTO-POLYMERIZATION FOR ADDITIVE MANUFACTURING

(71) Applicant: OPT Industries, Inc., Medford, MA (US)

(72) Inventors: Andre Schmeing, Somerville, MA (US); Jifei Ou, Medford, MA (US)

(73) Assignee: OPT Industries, Inc., Medford, MA (US)

(21) Appl. No.: 18/684,425

(22) PCT Filed: Aug. 19, 2022
(86) PCT No.: PCT/US2022/040872

§ 371 Date: Feb. 16, 2024

Related U.S. Application Data
(60) Provisional application No. 63/235,613, filed on Aug. 20, 2021.

(51) Int. Cl. B29C 64/393; B29C 64/124; B33Y 10/00; B33Y 50/02

(52) U.S. Cl. CPC B29C 64/393; B29C 64/124; B33Y 10/00; B33Y 50/02

(57) ABSTRACT

Provided herein are systems and methods for 3D printing. The method can include providing a material model of a volume of photo-curable resin contained in a 3D printer, where a portion of the photo-curable resin is suitable for contact with radiation to cure a portion thereof. The systems and methods can further include providing a geometric model of a 3D object to be printed and choosing a printing methodology comprising a geometry and intensity of radiation to be projected onto the photo-curable resin as a function of time and a control parameter of the 3D printer. The systems and methods can further include minimizing an error between the cured portion of photo-curable resin as predicted by the material model of the photo-curable resin and the geometric model of the 3D object to be printed.

### RELATED APPLICATIONS

This Application is a Non-Provisional of Provisional (35 USC 119(e)) of U.S. Application Ser. No. 63/235,613, filed Aug. 20, 2021, entitled “CONTROL OF PHOTOPOLYMERIZATION FOR ADDITIVE MANUFACTURING”. This application claims priority to this application and incorporates the entire contents of this application by reference herein in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF INVENTION

Additive manufacturing technology, also known as 3D printing, allows for the manufacture of finished products with complex geometries that are difficult or impossible to make with other technologies. High-resolution stereolithography 3D printing, specifically Digital Light Processing (DLP) printing technology, can allow printing resolutions of less than 100 micrometers (μm). High-resolution 3D printing allows one to produce intricate structures to reduce object weight, construct metamaterials, realize biomimicry design, or simply achieve aesthetic surface textures.

Although the resolution of recent 3D printers has been improving, some applications can still be limited by inadequate resolution. Some methods of improving resolution can involve trading off printing speed or constraining printable geometry.

### SUMMARY OF INVENTION

However, the present disclosure recognizes that certain aspects of 3D printing such as print resolution and/or print speed can be improved by providing a model that considers the chemical and physical properties of the photo-curable resin, and considers how the printing methodology interacts with those properties to print the desired object.

In an aspect, provided herein is a method for 3D printing. The method can comprise: providing a material model of a volume of photo-curable resin contained in a 3D printer, where a portion of the photo-curable resin is suitable for contact with radiation to cure a portion thereof; providing a geometric model of a 3D object to be printed; and choosing a printing methodology comprising (i) a geometry and intensity of radiation to be projected onto the photo-curable resin as a function of time and (ii) a control parameter of the 3D printer, by minimizing an error between the cured portion of photo-curable resin as predicted by the material model of the photo-curable resin and the geometric model of the 3D object to be printed.

In some embodiments, the method further comprises operating the 3D printer according to the printing methodology, thereby printing the 3D object.

In some embodiments, the geometry of radiation projected onto the photo-curable resin is not a series of slices of the geometric model of the 3D object to be printed.

In some embodiments, the intensity of radiation is not constant.

In some embodiments, at least some radiation is projected continuously until the 3D object is printed.

In some embodiments, the control parameter of the 3D printer is print speed.

In some embodiments, the radiation is ultraviolet (UV) radiation.

In some embodiments, the radiation is directed upon an open surface of the photo-curable resin.

In some embodiments, the radiation is directed through a transparent window in contact with the photo-curable resin.

In some embodiments, the cured photo-curable resin is disposed on a pliable substrate, which pliable substrate is moved through the volume of photo-curable resin.

In some embodiments, the printing methodology is chosen with the assistance of heuristics, optimal control theory, model predictive control, or machine learning.

In some embodiments, the printing methodology is chosen with the assistance of finite element modeling (FEM).

In some embodiments, the printing methodology is chosen with the assistance of computational fluid dynamics (CFD).

In some embodiments, the printing methodology is chosen with the assistance of cellular automata.

In some embodiments, the printing methodology is chosen by: providing a set of rules that describe changes in one or more state properties in response to the printing methodology; and minimizing an error between the desired value of the first state property and a value of the first state property in the photo-curable resin, as predicted by the material model subject to the set of rules, where the geometric model of the 3D object to be printed is parsed into a plurality of cells, wherein each cell is assigned a desired value of a first state property, and where the material model divides the volume of photo-curable resin into a plurality of volumetric elements, wherein each volumetric element has a set of values corresponding to said one or more state properties including the first state property.

In some embodiments, the rules determine the values of the state properties of the plurality of cells and/or the volumetrics according to a cellular automata model.

In some embodiments, the error is a difference between the desired value of the first state property and a value of the first state property in the photo-curable resin.

In some embodiments, the first state property is a degree of curing of a photo-curable resin.

In some embodiments, the minimization is performed using heuristics, model predictive control, optimal control theory, or machine learning.

In some embodiments, the rules are associated with curing and flow of the photo-curable resin.

In some embodiments, the first state property is associated with a location or a curing state of the photo-curable resin.

In some embodiments, the first state property is a ratio of cured to uncured resin, ratio of overcured to cured resin, cumulative exposure to radiation, viscosity, energetic state, mechanical momentum, or any combination thereof.

In some embodiments, the volumetric elements are modeled using cellular automata or finite element methods.

In some embodiments, the volumetric elements are supported by measurements based on state estimation algorithms such as Kalman-filters.

In some embodiments, the set of rules comprise radiation intrusion into the photo-curable resin, distribution of radiation through resin depending on its cured state, material flows, mechanical stress, mechanical deformation, chemical degradation due to radiation, or any combination thereof.

In some embodiments, the geometry and intensity of radiation to be projected onto the photo-curable resin as a function of time at a first location takes into account an amount of radiation projected onto the photo-curable resin at a second location, which second location is in proximity to the first location.

In some embodiments, the second location and the first location are proximally located within a single layer of a sliced geometric model of the 3D object to be printed.

In some embodiments, the second location and the first location are in proximal layers of a sliced geometric model of the 3D object to be printed.

In some embodiments, the first location and the second location are substantially co-linear with a source of radiation.

In some embodiments, the printing methodology comprises, within a slice of a geometric model of the 3D object to be printed, directing radiation upon a first location and a second location of photo-curable resin at different times.

In some embodiments, the first location and second location are within a contiguous area of photo-curable resin to be printed.

In some embodiments, the first location is distal to the second location with respect to a geometric center of the contiguous area, and the first location is exposed to radiation before the second location.

According to one aspect a system configured to perform the method of any one of the preceding claims is provided. According to another aspect a system is provided. The system comprises a material model of a volume of photo-curable resin contained in a 3D printer, wherein a portion of the photo-curable resin is suitable for contact with radiation to cure a portion thereof, a geometric model of a 3D object to be printed, and a computing device configured to choose a printing methodology, wherein the printing methodology comprises (i) a geometry and intensity of radiation to be projected onto the photo-curable resin as a function of time and (ii) a control parameter of the 3D printer, and wherein the printing methodology is chosen by minimizing an error between the cured portion of photo-curable resin as predicted by the material model of the photo-curable resin and the geometric model of the 3D object to be printed.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter within this disclosure are contemplated as being part of the inventive subject matter disclosed herein.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

FIG. 1 shows an example of a system for printing from the bottom-up through a transparent window.

FIG. 2 shows an example of a system for printing from the top-down.

FIG. 3 shows an example of a system for printing on a pliable substrate.

FIG. 4 shows an example of an intersection 2D cut view into the cellular automata representation of the unit pillar.

FIG. 5 shows an example of printing a unit pillar by projection of a rasterized model of the unit pillar.

FIG. 6 shows an example of a state-space, a target-space, and an action-space.

FIG. 7 shows an example of a cellular automata approach to modeling the behavior of a photo-polymerizable resin.

FIG. 8 shows an example of a progression from resin (R) to cured resin (C) to overcured resin (O).

FIG. 9 shows an example of the distribution of UV radiation intensity (I) at the center versus the periphery of an x-y plane.

FIG. 10 shows an example of contrasting strategies for printing a unit cylinder where the methods described herein correct for lateral diffusion of UV radiation.

FIG. 11 shows an example of contrasting top-down views of two projection strategies for printing a unit cylinder.

FIG. 12 shows an example of the penetration of UV radiation intensity (I) through layers of resin in the z-direction.

FIG. 13 shows an example of contrasting strategies for printing a unit cylinder where the methods described herein correct for penetration of UV radiation into resin and previously printed layers.

FIG. 14 shows an example of contrasting top-down views of two projection strategies for printing a unit cylinder.

FIG. 15 shows an example of simultaneous printing and recoating.

FIG. 16 shows an example of a change in viscosity of the resin during curing over a distance from the periphery of an object being printed.

FIG. 17 shows an example of outside-in growth-cluster tracing strategy.

FIG. 18 shows an example of a layer-wise unfolding along time of the projection strategy into a 4-dimensional system.

FIG. 19A and FIG. 19B are a chronological development of printing a unit cylinder using outside-in tracing.

FIG. 20 shows an example of an implementation of the growth clustering strategy described herein for the printing of nasal swabs.

FIG. 21 shows an example of several x-y dimension data contours that are plotted according to their perimeter to area ratio.

FIG. 22 shows an example of tracking growth clusters as continual material areas in the x-y-z space.

FIG. 23 shows an example of a hybrid printing strategy that includes some growth clusters.

### DETAILED DESCRIPTION OF INVENTION

Materials for the additive manufacturing industry, commonly referred as 3D printing, can utilize a multitude of polymerization techniques to create 3D articles with desirable material performance properties for end-use applications.

The methods described herein can be used with any 3D printing system. The photo-curable resin can be any suitable resin that is capable of polymerization when exposed to radiation (e.g., ultraviolet (UV) radiation). The resin can be part of a formulation that can include a photo-initiator, a UV absorber, a pigment, a diluent, and one or more monomers or oligomers. In some cases, UV radiation interacts with the photo-initiator to start a free-radical mediated polymerization of the monomers and/or oligomers.

Traditionally, UV curable formulations used for additive manufacturing can include ethylenically (i.e., double bond) unsaturated oligomers and monomers (e.g., acrylates, methacrylates, vinyl ethers), diluents, photo-initiators, and additives. The oligomers and monomers can provide mechanical properties to the final product upon polymerization. Diluents can reduce overall formulation viscosity for case of processing and handling. Diluents can be reactive and can be incorporated into the polymer matrix of the finished article. Photo-initiators can form free radicals upon exposure to actinic radiation (e.g., through photolytic degradation of the photo-initiator molecule). The free radicals can then utilize the ethylenically unsaturated chemical groups to form vinyl-based polymers. Additives can include but are not limited to pigments, dyes, UV absorbers, hindered amine light stabilizers, and fillers. Additives can be used to impart useful properties such as color, shelf stability, improved lifetime performance, higher UV stability, etc.

Following polymerization, the printed article can be removed from the vat of photo-curable resin and washed of residual (non-polymerized) resin. Further processing steps can include additional curing of the printed resin or performing a secondary polymerization.

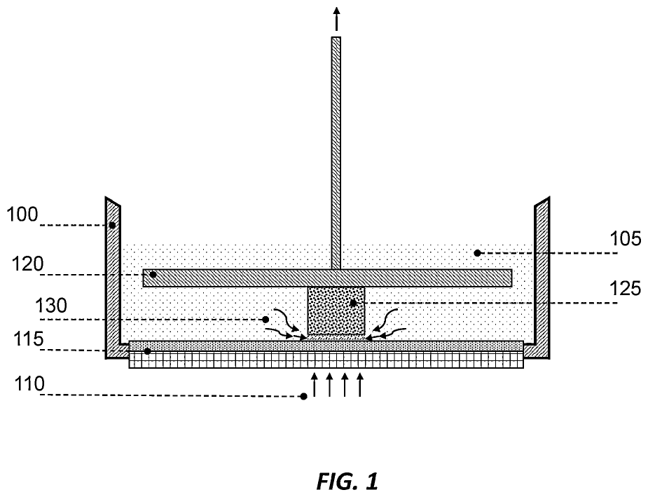

The methods described herein can be performed with any suitable 3D printing hardware (e.g., having digital light processors). FIGS. 1-3 show suitable systems for 3D printing. As seen in FIG. 1, printing can be performed from the bottom-up through a transparent window. Here, a container 100 can include a volume of photo-curable resin 105. UV light 110 can be projected through a glass plate or lens 115 onto a building platform 120. This can initiate polymerization into a cured article 125. The building platform can be moved upward, which can cause non-cured resin to flow and recoat 130 the printed article with resin such that a subsequent layer of the article can be printed.

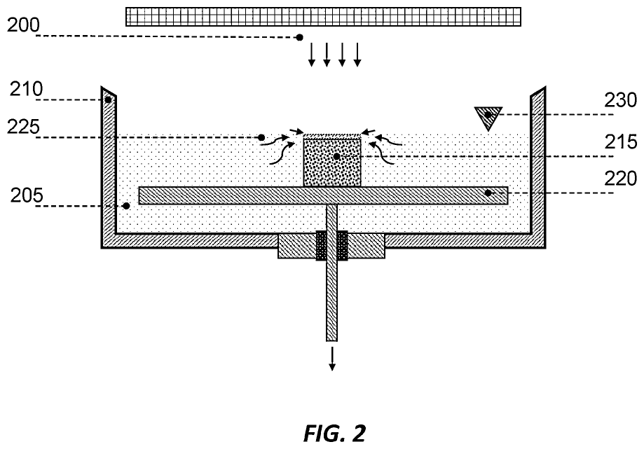

Similarly, FIG. 2 shows an example of a system for printing from the top-down. UV light 200 can be projected from the top-down onto an open surface of photocurable resin 205 that is contained in a vat 210. The cured article 215 can be printed onto a building platform 220 which can be moved downward into the vat of resin after each print layer. This can result in un-cured resin flowing 225 onto the surface of the cured article, which can be subsequently exposed to radiation to print another layer of the printed article. In some instances, this re-flow of resin is a rate limiting step of the overall process. Therefore, a recoating mechanism 230 (e.g., mechanical arm) can assist the recoating process.

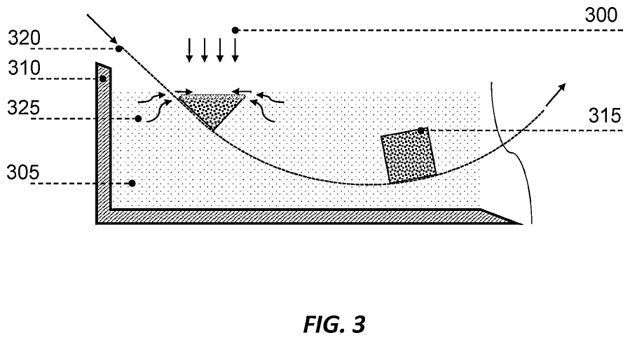

One potential limitation of the top-down and bottom-up systems described herein thus far is that they require resetting the print stage after each article is printed and are not continuous processes. In contrast, FIG. 3 shows an example of a system for printing on a pliable substrate. Here, the pliable substrate can be moved through a vat of the photo-curable resin in a continuous manner while article(s) are printed onto the substrate. UV radiation 300 can be projected onto a surface of a volume of photo-curable resin 305 in a container 310 that is exposed to air. The printed article 315 can be printed onto a pliable substrate 320 that is moved through the photo-curable resin. In some cases, if the printing is continuous, a recoating mechanism is not used and recoating 325 proceeds without mechanical assistance.

The 3D printing systems described above can be used to print a variety of articles. The shape of the article and its properties, such as the resolution of fine features, the consistency and extent of cure of the resin can be determined by the combination of many factors such as the mechanical attributes of the system, the chemical attributes of the resin, and the printing methodology. In an aspect, the present disclosure relates to the printing methodology which can include how the printer is operated (e.g., printing speed, continuously or in discrete print layers) and the location and intensity of projected radiation over time.

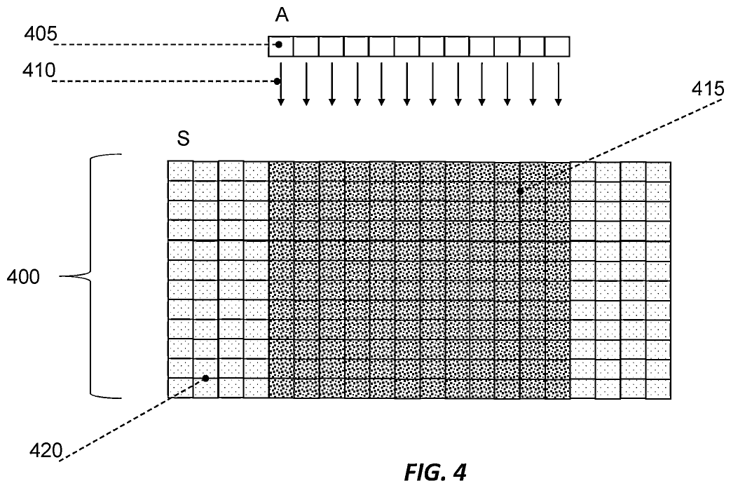

One printing methodology is to computationally “slice” a model of the 3D object to be printed into a series of layers that nominally constitute the 3D object when printed in succession. This process can be referred to as “rasterization” and printing of “rasterization data”. FIG. 4 shows an example of an intersection 2D cut view into the cellular automata representation of a unit pillar (i.e., cylinder). Here, a vat of photo-curable resin 400 is divided into volumetric elements (“voxels”), depicted here as a state-space (S). The rasterization data 405 determines locations and intensity for projection of radiation 410 onto the resin, conceptualized here as an action-space (A). This can result in some voxels of resin being cured 415 while leaving those that did not contact radiation uncured 420. However, FIG. 4 is an idealized example.

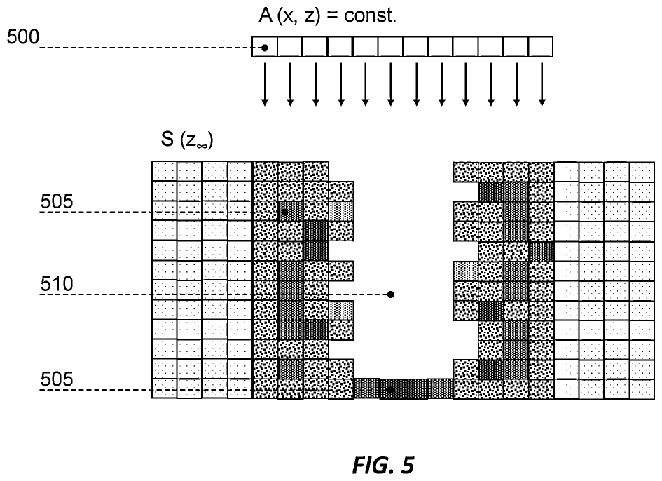

In some cases, projection of rasterization data does not result in a printed article that corresponds in shape or print quality to the desired article. This can be a result of many issues including a perfectly recoated new layer of resin not being present before each printing step. The resin can be highly viscous and the time needed to achieve perfect recoating may be too long to make the printing process practical. In reality, what can happen is depicted in FIG. 5. Here, the unit pillar is printed by projection of a rasterized model 500. This can result in both over-cured portions of the printed part 505 and a center portion 510 that is unreachable and does not print (e.g., because of a lack of resin reflow to this area).

However, the limitations of some methods of 3D printing as exemplified by FIG. 5 can be at least partially overcome using the systems and methods described herein. The method does not consist of simply projecting rasterization data onto the resin, but instead providing a geometric model of the object to be printed and solving for a radiation projection strategy that best achieves the desired model, subject to rules that govern behavior of the resin.

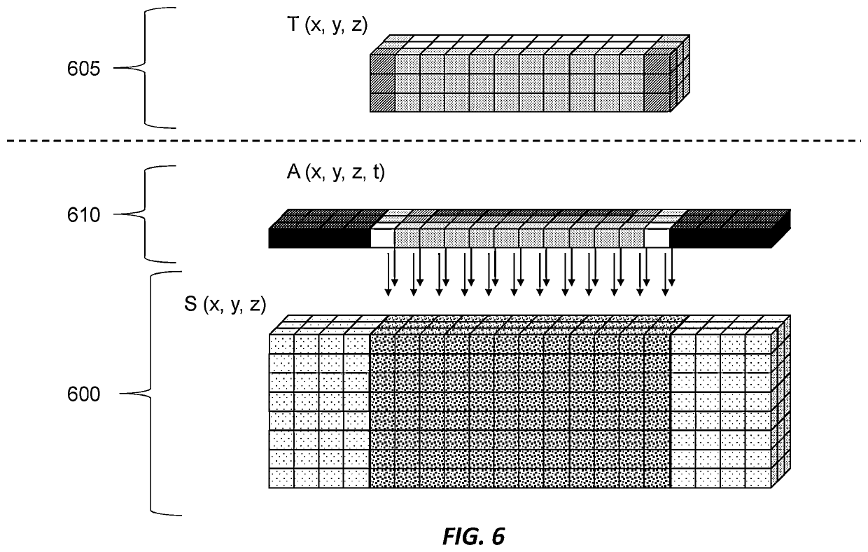

With reference to FIG. 6, the method can comprise providing a material model of a volume of photo-curable resin contained in a 3D printer 600 (also referred to herein as state-space. S). A portion of the photo-curable resin can be suitable for contact with radiation to cure a portion thereof. The method can further comprise providing a geometric model of a 3D object to be printed 605 (also referred to herein as the target-space, T). The method can include choosing a printing methodology 610 (also referred to herein as the action-space, A). The printing methodology can comprise (i) a geometry and intensity of radiation to be projected onto the photo-curable resin as a function of time and (ii) a control parameter of the 3D printer (e.g., print speed). The choosing (i.e., solving) can minimize an error between the cured portion of photo-curable resin as predicted by the material model of the photo-curable resin and the geometric model of the 3D object to be printed.

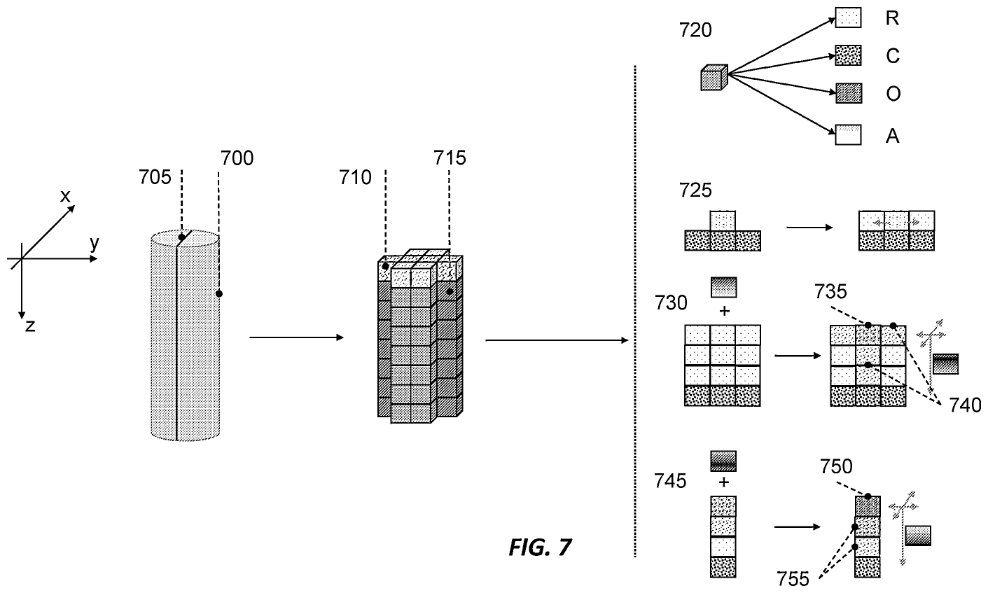

The action-space (i.e., projection strategy) can be solved for using a cellular automata approach. FIG. 7 illustrates a process for converting a 3D volume model into the 3D cellular automata. This approach can reconstruct the complex behaviors emerging from the continuous resin curing and printing process. Here, a unit circle 700 is modeled with a cross-section intersection cut 705. The model is divided into a plurality of volumetric elements 710 (voxels) that can be assigned values associated with a state property 715. In this visualization, the state property is the cured state of the resin with possible values 720 being uncured resin (R), cured resin (C), and over-cured resin (O). A projection of UV radiation (action, A) can interact with the resin to create certain behaviors in the resin and change the state property value of the voxels. The resin can flow 725, e.g., during recoating. UV radiation can contact 730 a selected voxel 735 to change its state to cured (from R to C), which can also partially cure 740 the voxels adjacent to the selected voxel. In some cases, a voxel can become over-cured. Additional UV exposure 745 to a cured voxel can change its state from cured to over-cured 750 (C to O). Adjacent voxels 755 can also become more cured (e.g., as the free-radical polymerization reaction proceeds into adjacent areas and/or as UV light diffuses or penetrates into adjacent areas). In some cases, each dimension of the state model can hold 8-bit unsigned integer values, e.g., ranging from 0 to 255.

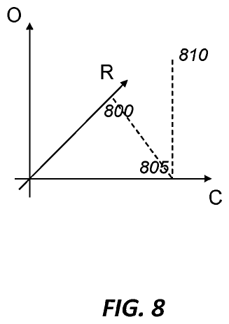

In the automata framework rules, some dimensions are directly dependent on one another, such as (R) and (C). With reference to FIG. 8, for each discrete state in the x-y-z spatial dimensions, a n-dimensional cell state space can be spanned open (e.g., three states being R. C, and O). In the state space, the temporal development can be tracked. For example, the cell state progression for a linear cure and overcure progression can be seen (which does not have to be linear). Starting from resin only 800, progresses on the assumed linear cure curve to a fully cured state, with no liquid resin left 805 and eventually under continued activation progresses into an overcured state 810. The R-C-O behavior can vary by resin material property, which can impact suitable projection strategies for the process.

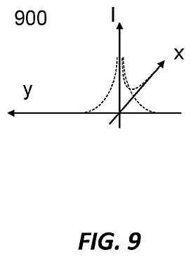

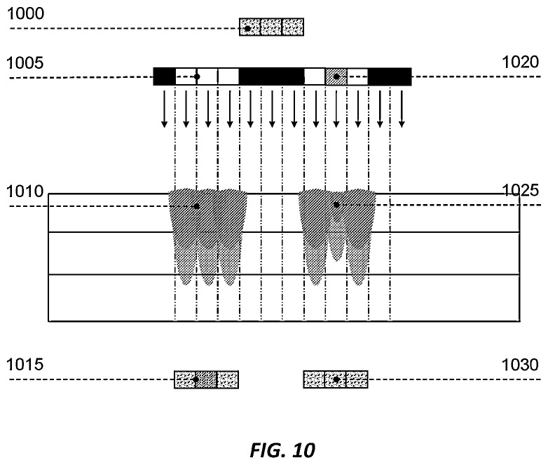

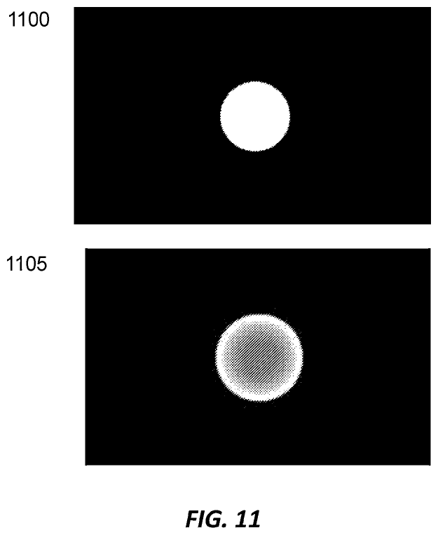

The methods described herein can result in a desired or near-desired amount of resin curing within a layer (inter-layer). For example, FIG. 9 shows that a model of the state-space 900 can have the intensity (I) of UV radiation delivered by the 3D printer be largest at the center of the projected area (x,y plane) and decay toward the periphery. In this case, the object to be printed (e.g., unit cylinder) in FIG. 10 can be divided into three voxels wide along a single print layer (target space) when viewed from the side 1000. A first projection strategy 1005 (e.g., of simple rasterization data) has the same intensity of radiation projected onto the resin at each of the voxel locations. This can result in some of the radiation from the peripheral voxels diffusing 1010 into the center voxel (and vice-versa). This strategy can result in the center voxel being over-cured 1015. In contrast, a second projection strategy can be solved for using the methods described herein. In this case, the center voxel in the action space 1020 delivers less intensive radiation (depicted as gray instead of white). This can compensate for the effect of radiation from adjacent voxels diffusing into the center voxel 1025 and reduce or eliminate over-curing in the center voxel 1030. A top-down view of the contrasting projection strategies is shown in FIG. 11. Here, the first projection strategy 1100 has a constant amount of radiation projected across the full cross-section of the cylinder, while the second projection strategy 1105 has less radiation projected in the center so that the center of the printed object does not become over-cured.

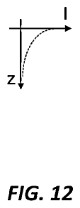

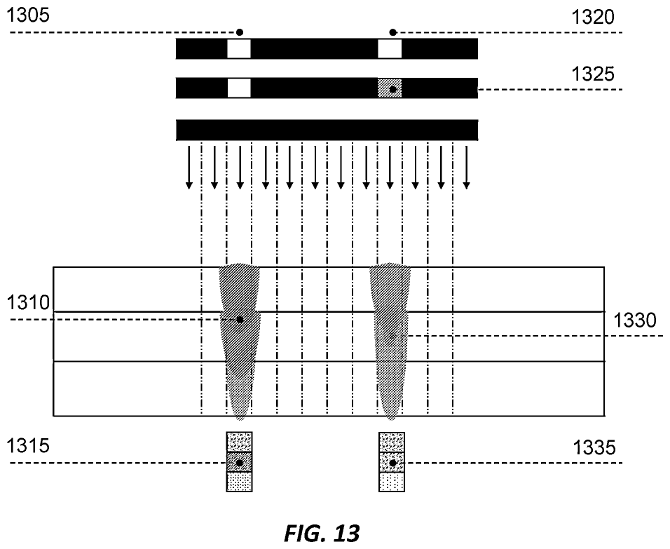

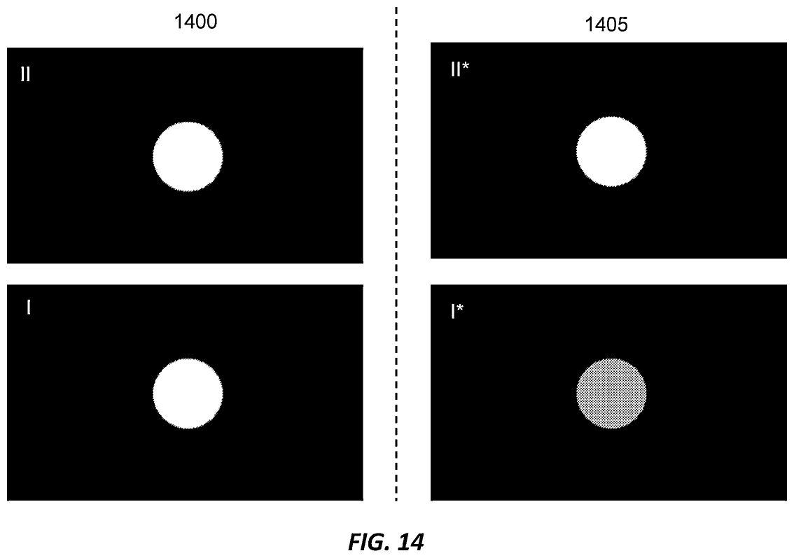

The methods described herein can result in a desired or near-desired amount of resin curing between layers (intra-layer). For example, FIG. 12 shows that a model of the state-space can have the intensity (I) of UV radiation penetrate through the resin and previously printed layers of the object. In this case, the object to be printed (e.g., unit cylinder) in FIG. 13 can be divided into two voxels found in subsequent layers (target space) when viewed from the side 1300. A first projection strategy 1305 (e.g., of simple rasterization data) has the same intensity of radiation projected onto the resin for each of the two layers. This can result in some of the radiation from the second layer penetrating 1310 into the earlier printed layer. This strategy can result in the first-printed voxel being over-cured 1315. In contrast, a second projection strategy 1320 can be solved for using the methods described herein. In this case, the first-printed voxel in the action space delivers less intensive radiation 1325 (depicted as gray instead of white). This can compensate for the effect of radiation from subsequent voxel penetrating into the first-printed voxel 1330 and reduce or eliminate over-curing in the first-printed voxel 1035. A top-down view of the contrasting projection strategies is shown in FIG. 14. Here, the first projection strategy 1400 has a constant amount of radiation projected for both layers of the cylinder, while the second projection strategy 1405 has less radiation projected in the first layer so that the first layer does not become over-cured.

The methods described herein can be used to choose printing methodologies that alter not just the intensity of radiation projected, but also the timing of projection. In some cases, the article is not printed in a strictly layer-by-layer manner. For example, different portions of a layer can be printed at different times. Or the use of layers (and rasterization data) can be dispensed with and the article can be printed continuously. The movement of the build platform and/or pliable substrate and projection of radiation can be simultaneous. This can assist the recoating process.

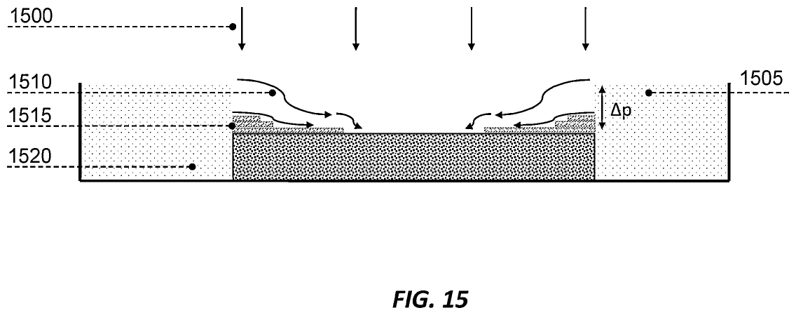

With reference to FIG. 15, radiation 1500 can be projected onto a photo-curable resin 1505. The recoating flow of resin 1510 can flow over the partially cured resin 1515 that is on the peripheral surface of the printed article 1520. The methods described herein can improve the process of recoating the absence of mechanical assistance. A pressure gradient (Δp) can be established along the print direction from already cured part to the resin boundary (e.g., either resin top level, or container bottom). The pressure gradient can cause a flow of resin from the resin bath into the printing area that is dependent on a multitude of fluid dynamics parameters. Many of these parameters can be dependent on mechanical process layout (e.g., resin surface flow speed), material properties (e.g., viscosity of the resin), or process parameters (e.g., print speed resulting movement of the cured part).

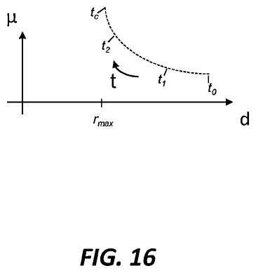

There can be a relationship between maximal achievable printing speed and resin penetration depth. Another relevant process parameter can be the maximal printable diameter (i.e., model intersection area) in relation to the print speed, which can depend on the recoating flow as illustrated in FIG. 16. For continuous printing (progression from to where resin enters the curing zone to t_{c} where it is cured and integrated into the printed article), while flowing into the center of the printed model intersection area (d), the resin is already starting to be cured. However, the resin polymerization reaction increases the resins viscosity (μ). The viscosity increase can be exponential in relation to absorbed UV energy. As a result, the maximal achievable printable build diameter (rₘₐₓ) can be constrained due to the rapid increase of resin viscosity (e.g., limited to a few millimeters in some cases).

As a guideline, the maximal achievable model intersection diameter can be proportional to the (e.g., average) recoating flow speed of the resin times the time period to fully cure resin under the UV projection (approx. v_{f}×t_{c}×2=dₘₐₓ). The UV projection intensity can be adjusted under the constraint of a minimal threshold value to initiate the photopolymerization process, with the UV intensity being inversely proportional to the time period to fully cure resin (Iᵤᵥ ∝t_{c}⁻¹). While the constraint of maximal building speed primarily affects the productivity and yield of the process, the maximal achievable build intersection diameter for any chosen speed additional can constrain the achievable design space. The methods described herein introduce a projection strategy to exceed these constraints via non-static UV intensities per projection layer pushing the boundaries of maximal producible part intersection diameter.

In some cases, the shape and dimensionality of the action space does not equal the target space. The action space (A) can be chosen for projection strategies yielding the closest match of physicalization in state space (S) compared to target space (T).

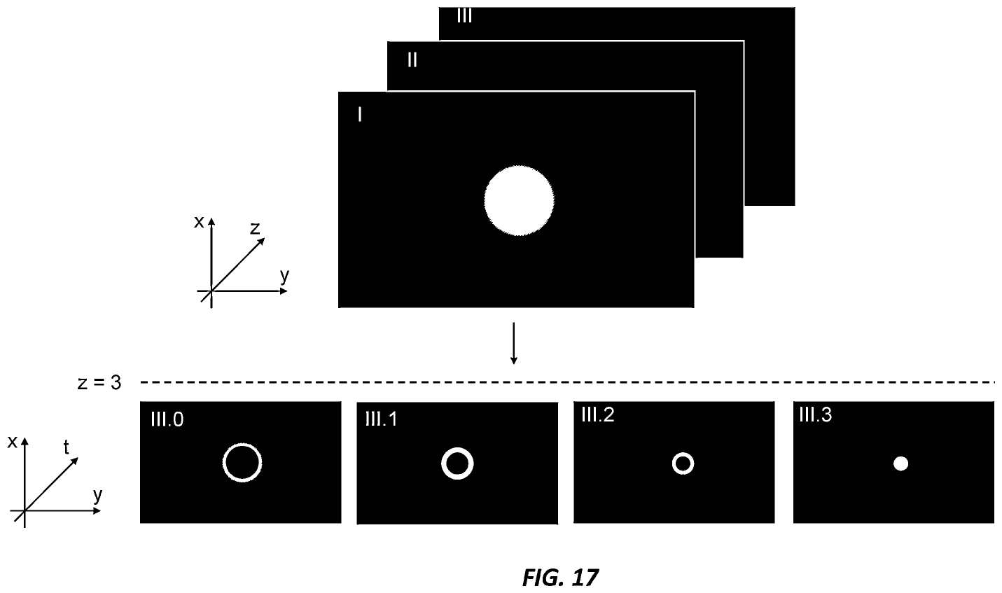

FIG. 17 shows an example of sub-layering to unfold the projection along the time. In the top of the illustration (above the dotted line) the rasterization data is presented as source and base from which the sub-layering starts (i.e., the target-space, T). The rasterization can be defined in spatial x-y-z coordinates and gray scaled voxel data. Starting from the rasterization data, each layer (z-layer in this case) can be unfolded along its projection time into a time dimension, visualized in the bottom part of the illustration for the z=3 layer. Within the first layer the x-y pixel slice data is within itself assigned a temporal projection strategy. Practically, the main restriction to the sub-layering discretization time period (how many sub-layers are introduced) is the fps (frames-per-second) maximum of utilized light projection engine. The third (III) layer of the rasterization data is processed into multiple sub-layers III.O III.1 III.2 III.3 (or more) to be projected in a time series.

FIG. 17 is an example of outside-in growth-cluster tracing strategy. This strategy is an approach to extend the design space boundaries by pushing the limit of printable maximal model intersection diameter (i.e., cross sectional area of the article). A used herein, “growth clusters”, can be identified within the target-space as cohesive clusters of material within the model that potentially exceed the traditional maximal producible intersection diameter. For every growth cluster, a strategy can be computed that optimizes for resin flow into the clusters center. This can allow full recoating while also ensuring to fully cure of the entire cluster. Tracing the cluster intersection of every z-layer as seen in the bottom of FIG. 17 can be a successful and efficient way of doing so. The effect illustrated here can be achieved by increasing the diameter of two statically offset erosion kernels (morphological image processing operation).

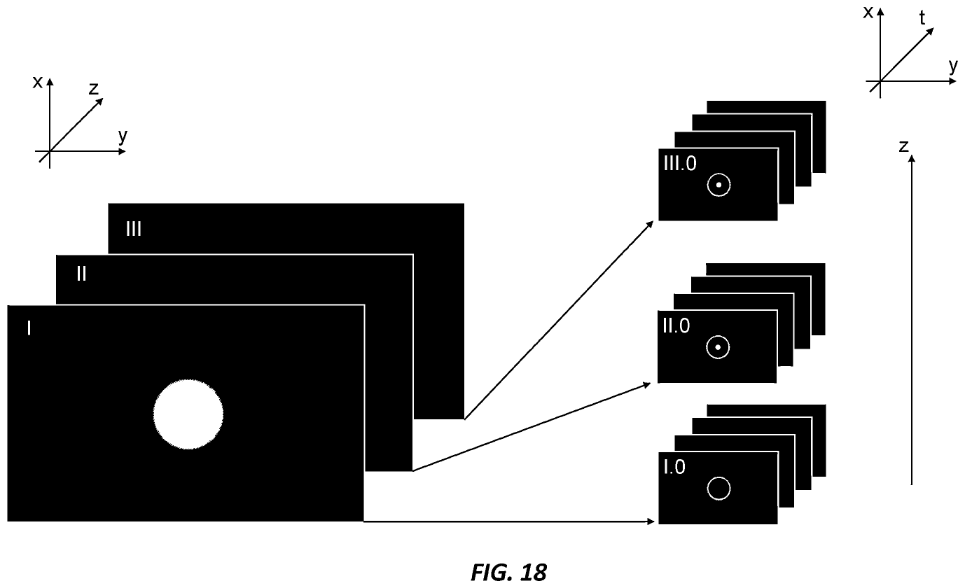

FIG. 18 presents a layer-wise unfolding along time of the projection strategy into a 4-dimensional system. There can be sub-layers through time for each discretization step in the projection dimension (the z vector in this case) into a x-y-z spatial +t temporal reference system. The projection sequences of each z layer can be packed into arrays of individual sub layers of projection steps, visualized by I.0, II.0, III.0 as corresponding first array entry of each package.

Also shown in FIG. 18 are the effects that depend on the structure to be printed (defined by target-space, T). The strategy can overarch its own package of sub-layers. As shown here, this effect can be seen as the white inner dot on the II.0 and III.3 sub-layers, which is missing on the I.0 sub-layer since it does not have any predecessors. The length of the sub-layer packed array is not necessarily pre-defined and can vary depending on the structure of rasterization data. This can lead to sub-layers affecting layers higher in z-dimension if necessary for the targeted structure to build up. In the illustration, the outside-in tracing for the rather large diameter unit cylinder can require a longer sequence of projection steps. Another effect can be that for parts of the structure to produce given in T, no sub-layering is necessary. This can reduce the array length of packaged temporal projection steps to one.

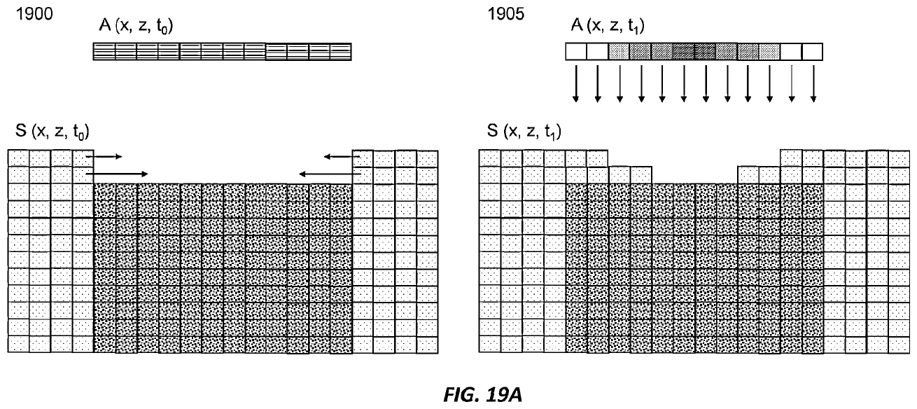

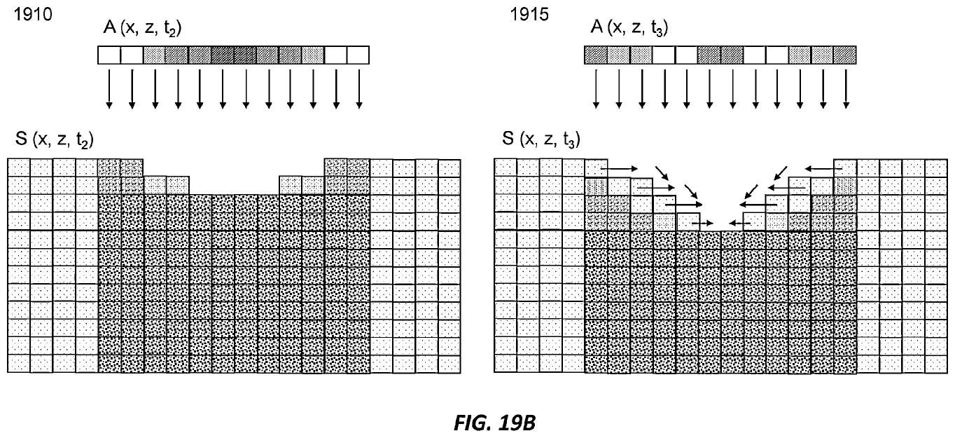

FIGS. 19A-19B are a chronological development of printing a unit cylinder using outside-in tracing. This can improve resin reflow over the printed area (e.g., by increasing the pressure drop driving the resin flow). Since the intersection cut is within the y-layer dimension, the action-space and state-space dimensionalities are reduced to A(x,z.t) and S(x.z.t,sₙ) respectively. The temporal sub-layer projections are discretized by the t variable and are also adopted to the tate-space (S) to be able to visualize the effects of individual sub-layers.

The first step 1900 is the part on the substrate moving down in the z layer direction. Induced by the movement in z direction, the resin starts to reflow from the exterior periphery on the part's recently cured surface (shown by inwards directed arrows). During this initial step, the action-pace (A) is shown as idle by scored-out UV projection above the resin bath. In the subsequent step 1905, resin already partially started to recoat the previous layer of the part's surface and the action-space (A) sets a first projection. This projection is an outside-in gradient of UV intensity in the y layer dimension. For the entire action-space in x-y-z space for the unit cylinder production, however, the projection is a hollow ring activation, just as shown above for outside-in tracing strategies.

Next, the first curing effects 1910 can be observed. Recently recoated resin absorbs radiation and is activated by the hollow ring activation of the action-space. The part is moved into the next z level direction layer while recoating from the exterior periphery. Development of the recently created concave structure continues. Additionally, the action-space changes into the next temporal UV projection sub-layer. This is the previously introduced outside-in projection pattern as an outside-in directed hollow ring for the unit cylinder. The growth cluster is traced from the outside to the inside by applying erosion image morphology operators with offseted kernel size for the growth cluster tracing strategy.

Finally, 1915 the effects of the outside-in tracing enable extension of the maximal producible intersection diameter. First, the outside-in activation of the production build up process cures areas under which recoated resin is located to avoid overcuring. Additionally, the recoating into the part's middle can be facilitated through the concave structure. Furthermore, completely uncured resin is allowed to flow into the part's center behind the hollow projection pattern. As explained here, in the case of full projection without this outside-in tracing, the resin's viscosity would increase exponentially with UV exposure and make it impossible to recoat and cure further than a certain threshold. This boundary can be bypassed through this projection strategy described herein.

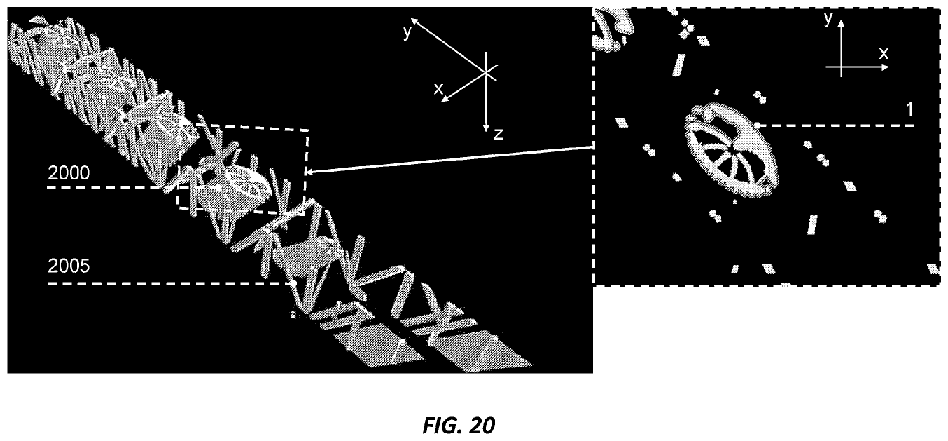

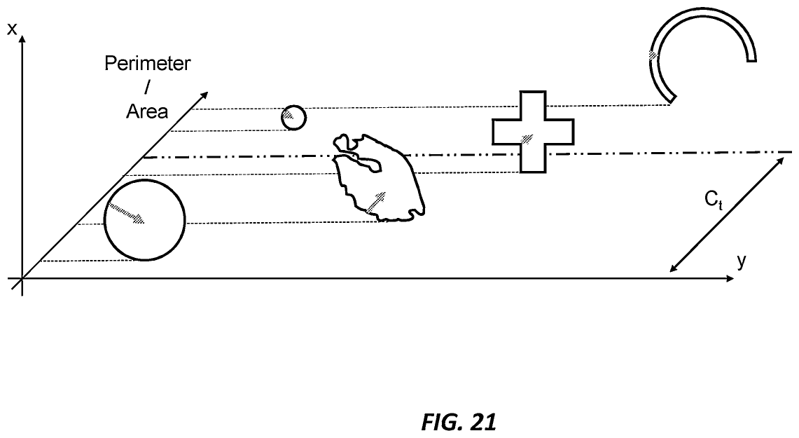

FIG. 20 shows an implementation of the growth clustering strategy described herein for the printing of nasal swabs. The window 2000 within the x-y-z space shows a zoom in on an area of interest for a growth cluster. The support structure 2005 of the part around the circular shaped swabs in this case is not recognized as having growth clusters. Generally, growth clusters are any cohesive material areas that are limited by recoating rate when printed. Thus, the thresholds from when parts of a model are considered growth clusters also depends on the hardware capabilities, the viscosity of the resin, and the like. In this example, the swab's circular shape exceeds these limitations and are identified as such. One way of detecting a growth cluster is to contour the x-y dimensions layers of the rasterization data. One computationally efficient way to decide whether a rasterization data contour is to be printed as a growth cluster is to analyze its perimeter to area ratio. FIG. 21 shows several exemplary x-y dimension data contours that are plotted according to their perimeter to area ratio. Potential recoating flows are indicated as gray arrows. Generally, contour morphologies with higher perimeter to area ratios are easier to be recoated from the exterior periphery. From this understanding, circular structures have the maximal perimeter to area ratio and are hardest to recoat, while more linearly shaped structures are easier to recoat. Depending on hardware constraints and process parameters such as printing speed, a perimeter to area threshold Ct can be defined for which a contour is to be identified as a growth cluster.

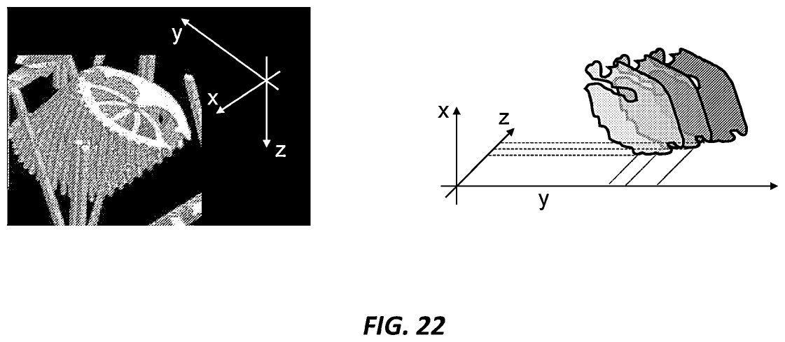

Turning attention to FIG. 22, once the growth clusters are identified in the x-y layer, one also tracks them as continual material areas in the entire x-y-z space. Different approaches can be used to describe growth clusters in their continuity across the 3D x-y-z space. One way is to match the contours across the z-layer dimension through their shape morphology and contour parameters. This means that for each layer, all contours are matched to their corresponding successors and predecessors through cluster classification by the means of area, perimeter, area to perimeter ratio, geometric center, orientation, area of overlap, and the like to find degrees of matching across z-space. The basic principle of matching the follow-up contours with a growth cluster is shown for the swab data. Other suitable methods of keeping track of growth cluster areas in the 3D spatial space of the rasterization include true 3D material cluster detection or pre-defined growth cluster areas or given through the model data.

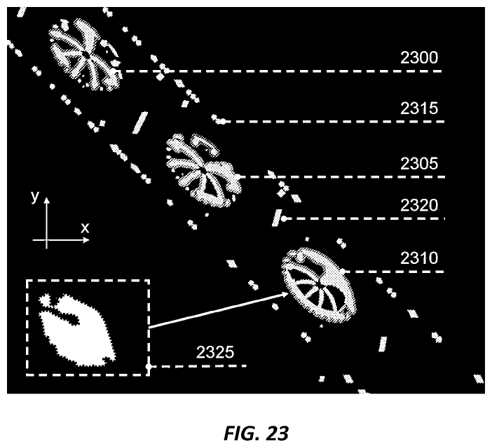

FIG. 23 shows a hybrid strategy including multiple printing strategies. The decision between the spatial areas for which to various strategies can be decided using growth cluster contour identification and matching over the z dimension. Three growth clusters are identified 2300, 2305, 2310 and are printed using an outside-in strategy. They are detected areas within an excerpt z layer for outside-in printing due to their binary contours exceeding the chosen perimeter to area ratio. Peripheral support structures 2315, 2320 are not identified as growth clusters and are printed using the techniques described above that correct for UV penetration from subsequently printed layers and from adjacent areas within a layer. An example of a closed contour of the third growth cluster 2325 is shown. In this case of nasal swab rasterization data packed into a support rack, the swab bulbs are recognized as growth clusters whereas the support structures are not printed outside-in.

Also, it should be appreciated that one or more 3D printing systems may be used to implement the systems and methods described herein. For example, some embodiments may be used in conjunction with one or more systems described in U.S. patent application Ser. No. 16/552,382, filed Aug. 27, 2019, or U.S. patent application Ser. No. 17/668,503, filed Feb. 10, 2022, each of which is incorporated herein in its entirety. However, it should be appreciated that other printer methods and systems may be used with embodiments as described herein.

The systems and methods described herein can be implemented using any suitable computational method or file format, such as described in PCT Patent Application Serial Number PCT/US2021/023962, filed Mar. 24, 2021, which is incorporated herein in its entirety.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. A method for 3D printing, the method comprising:
a. providing a material model of a volume of photo-curable resin contained in a 3D printer, wherein a portion of the photo-curable resin is suitable for contact with radiation to cure a portion thereof;
b. providing a geometric model of a 3D object to be printed; and
c. choosing a printing methodology comprising (i) a geometry and intensity of radiation to be projected onto the photo-curable resin as a function of time and (ii) a control parameter of the 3D printer, by minimizing an error between the cured portion of photo-curable resin as predicted by the material model of the photo-curable resin and the geometric model of the 3D object to be printed.

2. The method of claim 1, further comprising operating the 3D printer according to the printing methodology, thereby printing the 3D object.

3. The method of claim 1, wherein the geometry of radiation projected onto the photo-curable resin is not a series of slices of the geometric model of the 3D object to be printed.

4. The method of claim 1, wherein the intensity of radiation is not constant.

5. The method of claim 1, wherein at least some radiation is projected continuously until the 3D object is printed.

6. The method of claim 1, wherein the control parameter of the 3D printer is print speed.

7. The method of claim 1, wherein the radiation is ultraviolet (UV) radiation.

8. The method of claim 1, wherein the radiation is directed upon an open surface of the photo-curable resin.

9. The method of claim 1, wherein the radiation is directed through a transparent window in contact with the photo-curable resin.

10. The method of claim 1, wherein the cured photo-curable resin is disposed on a pliable substrate, which pliable substrate is moved through the volume of photo-curable resin.

11. The method of claim 1, wherein the printing methodology is chosen with the assistance of heuristics, optimal control theory, model predictive control, or machine learning.

12. The method of claim 1, wherein the printing methodology is chosen with the assistance of finite element modeling (FEM).

13. The method of claim 1, wherein the printing methodology is chosen with the assistance of computational fluid dynamics (CFD).

14. The method of claim 1, wherein the printing methodology is chosen with the assistance of cellular automata.

15. The method of claim 1, wherein the printing methodology is chosen by:
a. providing a set of rules that describe changes in one or more state properties in response to the printing methodology; and
b. minimizing an error between the desired value of the first state property and a value of the first state property in the photo-curable resin, as predicted by the material model subject to the set of rules,
wherein the geometric model of the 3D object to be printed is parsed into a plurality of cells, wherein each cell is assigned a desired value of a first state property, and
wherein the material model divides the volume of photo-curable resin into a plurality of volumetric elements, wherein each volumetric element has a set of values corresponding to said one or more state properties including the first state property.

16-25. (canceled)

26. The method of claim 1, wherein the geometry and intensity of radiation to be projected onto the photo-curable resin as a function of time at a first location takes into account an amount of radiation projected onto the photo-curable resin at a second location, which second location is in proximity to the first location.

27-29. (canceled)

30. The method of claim 1, wherein the printing methodology comprises, within a slice of a geometric model of the 3D object to be printed, directing radiation upon a first location and a second location of photo-curable resin at different times.

31. The method of claim 30, wherein the first location and second location are within a contiguous area of photo-curable resin to be printed.

32. The method of claim 30, wherein the first location is distal to the second location with respect to a geometric center of the contiguous area, and the first location is exposed to radiation before the second location.

33. (canceled)

34. A system comprising:
a material model of a volume of photo-curable resin contained in a 3D printer, wherein a portion of the photo-curable resin is suitable for contact with radiation to cure a portion thereof;
a geometric model of a 3D object to be printed; and
a computing device configured to choose a printing methodology, wherein the printing methodology comprises (i) a geometry and intensity of radiation to be projected onto the photo-curable resin as a function of time and (ii) a control parameter of the 3D printer, and wherein the printing methodology is chosen by minimizing an error between the cured portion of photo-curable resin as predicted by the material model of the photo-curable resin and the geometric model of the 3D object to be printed.
